(19) United States
(12) Patent Application Publication
(10) Pub. No.: US 2026/0146679 A1
(43) Pub. Date: May 28, 2026

(54) ARMATURE FOR USE WITH VALVE ACTUATION AND METHOD OF FABRICATING THE SAME

(71) Applicant: Cummins Inc., Columbus, IN (US)

(72) Inventors: Chitra Pratap Hinge, Old Sangavi (IN); Pedavegula Naga Satya Divya, Pune (IN); Chaitanya Pradip Wani, Pune (IN); Amol Jagannath Bobade, Pune (IN); Rajiv Girish Karnik, Pune (IN); Rajendra M. Bodake, Pune (IN); Dnyanesh Keshaorao Gawande, Pune (IN)

(21) Appl. No.: 19/379,111

(22) Filed: Nov. 4, 2025

(30) Foreign Application Priority Data
Nov. 21, 2024 (IN) 202441090532

(51) Int. Cl. F16K 31/06; F02M 59/46

(52) U.S. Cl. CPC F16K 31/0655; F16K 31/0675; F02M 59/46

(57) ABSTRACT

An armature is disclosed for use in an armature assembly associated with actuation of a valve, such as for fuel injectors, fuel cells, and/or fuel pumps. The armature includes a body having a first end with a flange and a shaft extending from the flange to a second end of the body. The second end includes a recessed surface configured to reduce stress on the armature upon impact. The armature can be fabricated from a lower strength material that is highly permeable, reducing residual magnetism in the armature to help de-latching and reduce end of injection delays.

### FIELD OF THE DISCLOSURE

The present disclosure generally relates to armature assemblies for valve actuation such as in fuel injectors, fuel cells, and/or fuel pumps, and more particularly, to armatures and fabrication of armatures for use in the same.

### BACKGROUND

Armatures can be used in armature assemblies for actuation of valves that use a solenoid, such as for fuel injectors, fuel cells, fuel pumps, and/or fluid flow control devices. Armatures can be manufactured by machining one or more blank pieces of metal material to form the armature in the desired configuration, dimensions, and finish. The machining process involves fabrication time that is devoted to each armature piece to be produced along with energy inputs, material waste, and facility cleaning. Armatures assembled from multiple pieces are thus more costly than armatures machined as a single piece. In addition, the armature can cause delays in closing the fuel injector at the end of injection due to residual magnetism of the armature material that is required to be employed to provide the desired stress resistance within the armature. Therefore, there remains a need for further improvement in this area.

### DISCLOSURE OF ILLUSTRATIVE EMBODIMENTS

For the purposes of clearly, concisely and exactly describing illustrative embodiments of the present disclosure, the manner, and process of making and using the same, and to enable the practice, making and use of the same, reference will now be made to certain exemplary embodiments, including those illustrated in the figures, and specific language will be used to describe the same. It shall nevertheless be understood that no limitation of the scope of the invention is thereby created, and that the invention includes and protects such alterations, modifications, and further applications of the exemplary embodiments as would occur to one skilled in the art.

### SUMMARY

An armature for use in an armature assembly associated with actuation of a valve, such as for fuel injectors, fuel cells, and/or fuel pumps, is disclosed. The armature includes a body having a first end with a flange and a shaft extending from the flange to a second end of the body. The second end includes a recessed surface configured to reduce stress on the armature upon impact. The armature can be fabricated from a lower strength material that is highly permeable, reducing residual magnetism in the armature to help de-latching and reduce end of injection delays.

In one embodiment of the present disclosure, an armature is provided that includes a body extending along a longitudinal axis between a first end and an opposite second end. The body includes a flange at the first end and a shaft extending from the flange. The shaft extends along the longitudinal axis from the flange to the second end of the body. The body includes a passage that extends along the longitudinal axis. The passage opens at the first and second ends of the body. The second end of the body includes an end surface extending around the passage. The end surface has a first portion extending around a second portion. The first portion of the end surface is flat, and the second portion of the end surface is recessed from the first portion toward the first end of the body.

In another embodiment of the present disclosure, a method of fabricating an armature for use in actuation of a valve is provided. The method includes a step of forming a monolithic metallic body using a metal material and a metal injection molding process and/or bar machining process. The monolithic metallic body is formed to include a flange at a first end of the monolithic metallic body and a shaft extending from the flange along a longitudinal axis. The shaft extends to a second end of the monolithic metallic body that is opposite the first end. A passage that extends along the longitudinal axis opens at the first and second ends of the monolithic metallic body.

This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The description herein makes reference to the accompanying drawings wherein like numerals refer to like parts throughout the several views, and wherein:

FIG. 1 is a schematic perspective illustrating certain aspects of an armature according to an example embodiment of the present disclosure.

FIG. 2 is a longitudinal cross-sectional view of the armature in FIG. 1.

FIG. 3 is an enlarged cross-sectional view of a portion of the armature in FIG. 1.

FIG. 4 is a schematic diagram of a metal injection molding and/or bar machining process to fabricate an armature according to an embodiment of the present disclosure.

FIG. 5 is a schematic flow diagram of a procedure for forming an armature using a metal injection molding process according to an embodiment of the present disclosure.

FIG. 6 is a cross-sectional view of an example fuel injector for an internal combustion engine that includes the armature of FIG. 1.

### DETAILED DESCRIPTION OF ILLUSTRATIVE EMBODIMENTS

In the following detailed description, reference is made to the accompanying drawings which form a part hereof, and in which is shown by way of illustration specific embodiments in which the present disclosure is practiced. These embodiments are described in sufficient detail to enable those skilled in the art to practice the present disclosure, and it is to be understood that other embodiments can be utilized and that structural changes can be made without departing from the scope of the present disclosure. Therefore, the following detailed description is not to be taken in a limiting sense, and the scope of the present disclosure is defined by the appended claims and their equivalents.

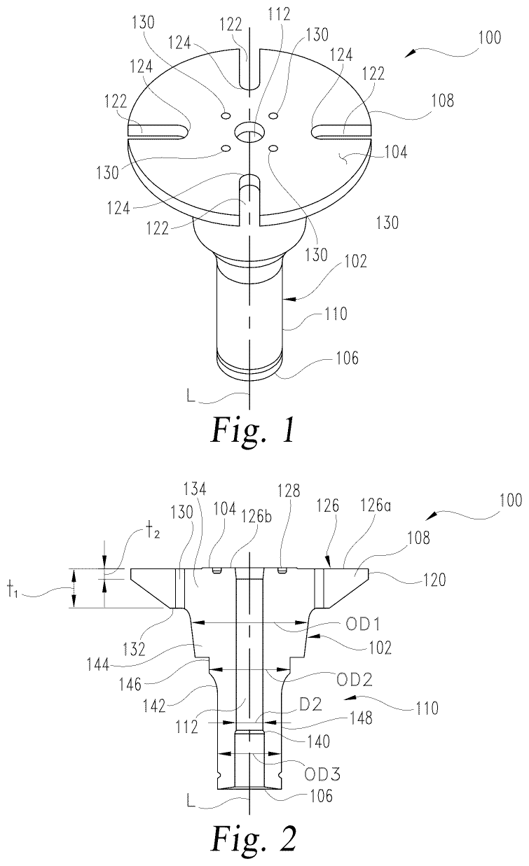

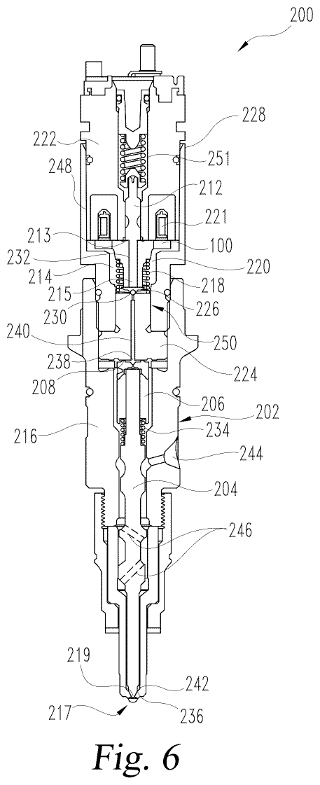

FIGS. 1-3 are illustrations associated with an armature 100 in accordance with an embodiment of the present disclosure. FIG. 4 is a schematic diagram of a fabrication process for an armature and FIG. 5 is a flow diagram of a method for fabricating armature 100 using a metal injection molding process according to an embodiment of the present disclosure. FIG. 6 is a detailed cross-sectional illustration of an embodiment of a fuel injector 200 to show an exemplary implementation of armature 100 in a valve 250 of a particular fuel injector. While the present disclosure describes particular configurations of fuel injector 200 and/or armature 100, one or more of these features described in the present disclosure may be omitted, and other features are not precluded. Armature 100 of the present disclosure can be used on any fuel injector, fuel cell, fuel pump, and/or flow control valve compatible with the features of the present disclosure.

As shown in these figures, in an embodiment of the present disclosure, armature 100 includes a body 102 extending along a longitudinal axis L between a first end 104 and an opposite second end 106. Body 102 includes a flange 108 at first end 104 and a shaft 110 extending from flange 108. Shaft 110 extends along longitudinal axis L from flange 108 to second end 106 of body 102. Body 102 includes a passage 112 that extends along longitudinal axis L. Passage 112 opens at first and second ends 104, 106 of body 102. Second end 106 of body 102 includes an end surface 114 extending around passage 112. End surface 114 has a first portion 116 extending around a second portion 118. First portion 116 of end surface 114 is flat and second portion 118 of end surface 114 is recessed from first portion 116 toward first end 104 of body 102.

In another embodiment of the present disclosure, a method 400 of fabricating armature 100 for use in actuation of a valve is provided. Method 400 includes a step 404 of forming a monolithic metallic body 102 using a metal material and a metal injection molding process and/or bar machining process. The monolithic metallic body 102 is formed to include flange 108 at first end 104 of monolithic metallic body 102 and shaft 110 extending from flange 108 along longitudinal axis L. Shaft 110 extends to second end 106 of monolithic metallic body 102 opposite first end 104. Passage 122 extends along longitudinal axis L and opens at first and second ends 104, 106 of monolithic metallic body 102.

Referring to FIGS. 1-2, armature 100 includes body 102 extending along longitudinal axis L from first end 104 to second end 106. Body 102 includes flange 108 at first end 104, and shaft 110 extending from flange 108 to second end 106. Flange 108 extends radially outwardly from and perpendicular to shaft 110. Flange 108 includes an outer edge 120 forming a circular shape, with flange 108 projecting radially outwardly from passage 112, and shaft 110 extending axially from one side of flange 108. In an embodiment, flange 108 is disc-shaped and shaft 110 is cylindrical in shape, and passage 112 extends longitudinally through flange 108 and shaft 110 along longitudinal axis L.

In an embodiment, flange 108 includes an outer diameter defined by outer edge 120 that is larger than the largest outer diameter portion defined by the outer surface of shaft 110. Flange 108 includes a plurality of slots 122 that extend through flange 108. Each of the plurality of slots 122 extends radially inwardly from outer edge 120 of flange 108 to a terminal end 124 of the corresponding one of the plurality of slots 122. In an embodiment, the plurality of slots 122 is four slots 122 spaced equi-angularly around flange 108.

In an embodiment, flange 108 includes an end surface at first end 104 of body 102 that includes an outer end face portion 126 and a recessed end face portion 128. Recessed end face portion 128 extends around passage 112, and outer end face portion 126 extends around recessed end face portion 128. Outer end face portion 126 may be planar and/or include one or more surfaces 126a, 126b that are offset from one another.

Recessed end face portion 128 at first end 104 is spaced radially inwardly from outer end face portion 126. Recessed end face portion 128 is offset into body 102 from outer end face portion 126 toward second end 106. In an embodiment, flange 108 also includes a second face 132 opposite outer end face portion 126. Second face 132 faces second end 106 and extends radially outwardly from shaft 110. In an embodiment, a plurality of through-holes 130 of flange 108 extend through outer end face portion 126 and second face 132.

In an embodiment, flange 108 includes a first flange portion 134 extending radially outwardly from the shaft 110 having a first thickness t1 between outer end face portion 126 and second face 132. Flange 108 also includes a second flange portion 136 between adjacent pairs of slots 122. Second flange portion 136 extends radially outwardly from the first flange portion 134 to the outer edge 120 of flange 108. Second flange portion 136 tapers from the first thickness t1 to a second, lesser thickness t2 between outer end face portion 126 and second face 132 at the outer edge 120 of flange 108. The reduction in mass of flange 108 using slots 122 and/or tapered second flange portion 136 assists in movement of the armature 100 during valve opening and closing operations.

In an embodiment, flange 108 includes a plurality of holes 130 that each extend axially through the outer end face portion 126 and second face 132. Each of the plurality of holes 130 is located between a corresponding pair of the plurality of slots 122. Holes 130 are cylindrical in the illustrated embodiment, but other shapes for holes 130 are also contemplated. In an embodiment, holes 130 are spaced equi-angularly about longitudinal axis L from one another around flange 108. Similarly, slots 122 can be spaced at an equi-angularly about longitudinal axis L at the same angle around flange 108 but located so that each hole 130 is positioned between a corresponding pair of slots 122. Other embodiments contemplate fewer than four holes 130 and/or slots 122, or more than four holes 130 and/or slots 122.

In an embodiment, holes 130 are diffusion holes that can influence fluid flow during all points of travel of the armature 100. During travel of the armature 100 in the direction toward first end 104, fluid on outer end face portion 126 compresses and can lead to high pressure spikes. The presence of diffusion holes 130 and/or slots 122 helps in diffusing squeeze film pressure spikes during armature travel and hence can increase a velocity of the armature 100. During travel of the armature 100 in a direction toward second end 106, fluid flows from second face 132 of flange 108 to the outer end face portion 126 via the diffusion holes 130 and thereby can reduce hydraulic drag on the armature 100 and increase the velocity.

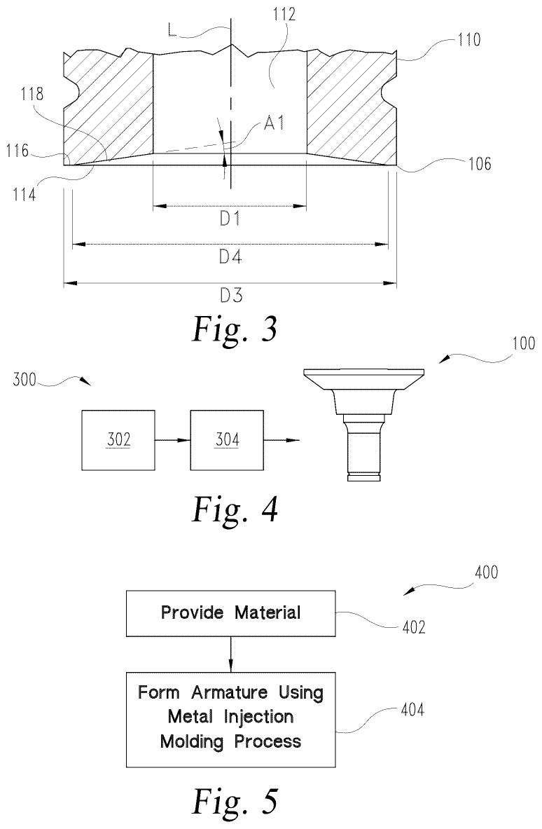

Referring further to FIG. 3, in an embodiment, passage 112 includes a first diameter D1 adjacent to second end 106 of body 102 and a second diameter D2 along a majority of a length of passage 112 between the first and second ends 104, 106 of body 102. First diameter D1 of passage 112 is greater than second diameter D2 of passage 112. In an embodiment, a lip 140 connects the transition of diameter D1 to diameter D2. In an embodiment, lip 140 is obliquely oriented to longitudinal axis L.

In an embodiment, shaft 110 of body 102 includes an outer surface 142 extending from flange 108 to second end 106. Outer surface 142 extends from second end 106 of body 102 to second face 132 of flange 108. In an embodiment, outer surface 142 has a stepped surface profile along a portion of the length of shaft 110.

In an embodiment, the stepped surface profile of outer surface 142 of shaft 110 includes a first shaft portion 144 adjacent to flange 108 having a first outer diameter OD1. The stepped surface profile also includes a second shaft portion 146 adjacent to first shaft portion 144. Second shaft portion 146 includes a second outer diameter OD2 that is less than first outer diameter OD1. The stepped outer surface profile of outer surface 142 of shaft 110 includes a third shaft portion 148 adjacent to second shaft portion 146. Third shaft portion 148 extends to second end 106 of body 102. Third shaft portion 148 has a third outer diameter OD3 that is less than the second outer diameter OD2.

Second end 106 includes an end surface 114 extending around longitudinal axis L. End surface 114 includes first portion 116 extending around second portion 118. In an embodiment, first portion 116 is flat and/or orthogonally oriented to longitudinal axis L. Second portion 118 is recessed from first portion 116 toward first end 104 of body 102. The recessed configuration of end surface 114 reduces stress on second end 106 and shaft 110 as armature 100 travels in a direction toward second end 106 to contact a stop surface during actuation of armature 100. In an embodiment, the stress reduction at first end 106 allows armature 100 to be fabricated from a lower strength material that is highly permeable, reducing residual magnetism in armature 100 to help de-latch armature 100 from a magnetic coupling with a solenoid and reduce end of injection delays.

In an embodiment, second portion 118 of end surface 114 is planar and/or obliquely oriented to first portion 116 and/or longitudinal axis L at a taper angle A1. In an embodiment, second portion 118 of end surface 114 is tapered at a taper angle A1 that ranges from 0.1 degrees to 4 degrees from first portion 116 to provide the recessed configuration for stress reduction. In an embodiment, second portion 118 of end surface 114 is tapered at a taper angle A1 that ranges from 0.1 degrees to 1 degree from first portion 116 to provide the recessed configuration for stress reduction. In an embodiment, second portion 118 of end surface 114 is tapered at a taper angle A1 that is, or is about, 0.5 degrees plus or minus 0.4 degrees from first portion 116 to provide the recessed configuration for stress reduction. Other embodiments contemplate non-planar configurations for second portion 118 of end surface 114, such as concavely curved and/or non-planar configurations.

In an embodiment, first portion 116 of end surface 114 has an outer diameter D3 and an inner diameter D4. First portion 116 defines a contact area between the outer and inner diameters D3 and D4. Second portion 118 has an outer diameter D4 coinciding with the inner diameter D4 of first portion 116, and an inner diameter D1 coinciding with the diameter of passage 112. Second portion 118 defines a recessed area between diameters D1 and D4.

In an embodiment, a ratio of an area of second portion 118 to an area of the first portion 116 ranges from 4 to 7 so that the contact area and stress distribution at end surface 114 is better distributed along second portion 118 and first portion 116. In another embodiment, the ratio of the areas of second portion 118 to first portion 116 is between 5 and 6 so that the contact area and stress distribution at end surface 114 is better distributed along second portion 118 and first portion 116.

Referring to FIG. 4, a schematic diagram of a metal injection molding process and/or bar machining process 300 for molding and/bar machining armature 100 into the disclosed configuration is shown. Process 300 includes a feedstock 302 of metal material. In an embodiment, feedstock 302 is a powdered metal material mixed with a binder in sufficient volume to be fed into an injection mold 304 for shaping and solidification to produce an output having the configuration of armature 100. In an embodiment, feedstock 302 is a bar of metal material to be machined with a machine tool 304.

In an embodiment, the metal material for feedstock is a highly permeable metal material that minimizes residual magnetism of armature 100. The stress reduction provided by the recessed configuration of end surface 114 at second end 106 of armature 100 allows such material to be employed in the fabrication of armature 100, which is lower in cost than materials employed in prior art armatures such as carbon steel. In an embodiment, the material for armature 100 is Fe₃Si or other suitable ferritic soft-magnetic silicon alloy material capable of metal injection molding. Other embodiments contemplate other types of metal materials that are capable of being metal injection molded, machined, or otherwise fabricated to form armature 100 having the end surface 114 recessed configuration according to the present disclosure.

Referring to FIG. 5, a method 400 for forming armature 100 as a one-piece monolithic body using a metal injection molding process is disclosed, such as by using metal injection molding process 300 discussed above. Method 400 includes an operation 402 to provide a feedstock of material, such as feedstock 302 from which to mold the armature 100. Method 400 further includes an operation 404 to form armature 100 using a metal injection molding process, such as by injecting feedstock 302 into injection mold 304, which is configured to mold the feedstock 302 into the configuration of armature 100 having the recessed end surface 114.

With reference to FIG. 6, there is illustrated a cross-sectional view of an embodiment of fuel injector 200 with armature 100 employed in association with valve 250 of fuel injector 200. Fuel injector 200 generally includes an injector body 202, an elongated needle valve 204, a needle sleeve 206, a needle seal 208, armature 100, and a plunger 112 extending through passage 112 of armature 100. Injector body 202 includes upper chamber 214 and lower chamber 216 for receiving a plurality of components therein as will occur to one of skill in the art with the benefit and insight of the present disclosure.

Armature 100 is configured to move up and down in injector body 202 to facilitate opening and closing of valve 250 of fuel injector 200. Stator assembly 222, which includes solenoid 248, may be disposed directly above armature 100 so that when solenoid 248 is in an active state, armature 100 moves to an upward position. When solenoid 248 is in an inactive state, such as the end of injection, armature 100 moves to a downward position. An air gap such as, for example, air gap 232 may provide a distance between stator assembly 222 and armature 100. As discussed above, armature 100 can be made from highly permeable metal material and therefore less likely to retain residual magnetism, which helps de-latch armature 100 from its magnetic coupling with solenoid 248 and reduce end of injection delays.

An inner cavity within upper chamber 214 of injector body 202 receives armature 100, plunger 212, an armature spring 218, a spring disk 220, and stator assembly 222. An inner cavity within lower chamber 216 receives needle valve 204, needle sleeve 206, needle seal 208, a pilot valve seat 224, and a check ball 226. Upper chamber 214 provides a lower pressure environment of fuel injector 200 relative to a high pressure environment below check ball 226. Stator assembly 222 is fixed within upper chamber 214 and retained in place by retainer 228. A bottom surface of stator assembly 222 is a precision calibrated distance away from an upper surface of armature 100. At the other end of armature 100 is a check ball retainer 230 that supports armature 100 via abutting engagement.

A middle section of plunger 212 includes an angled shoulder 213 disposed on the upper surface of armature 100 which creates a reciprocal connection such that when armature 100 moves in an upward direction, plunger 212 moves therewith. Armature spring 218 is biased against flange 108 of armature 100 and biases armature 100 and plunger 212 in an upward direction. Armature 100 includes passage 112 that receives a shaft 215 of plunger 212 therethrough. An outer diameter of the shaft 215 is sized and configured to provide a close or match fit in relation to an inner diameter of passage 112 while still permitting sliding movement of plunger 212. This close/match fit inhibits fuel leakage between the outer diameter of the shaft 215 of plunger 212 and the inner diameter of passage 112 while permitting relative sliding movement.

Lower chamber 216 including an inner cavity houses needle valve 204, needle sleeve 206, needle seal 208, pilot valve seat 224, and check ball 226. The inner cavity also houses a needle spring 234 that biases needle valve 204 in a downward direction and applies a closing spring force to needle valve 204 thereby preventing fuel from exiting through injector orifice 236. Needle seal 208 includes control orifices 238 integrated within needle seal 208 to admit fuel into needle seal 208 while a proximal end of needle valve 204 is positioned within needle seal 208. Needle seal 208 is disposed above needle valve 204 and includes end points that terminate adjacent needle sleeve 206.

A surface of a lower end of pilot valve seat 224 abuts a top surface of needle seal 208, while a surface of an upper end of pilot valve seat 224 is disposed immediately below armature spring 218. Pilot valve seat 224 further includes valve seat central passage 240 that extends longitudinally from the lower end of pilot valve seat 224 toward the upper end.

Needle valve 204 moves up and down longitudinally in the injector body 202 to selectively start and stop fuel injection from the injector body 202. A distal end 217 of needle valve 204 is located at a distal portion of the injector body 202 which defines a needle valve seat 242 that seats a tip 219 of needle valve 204 in between fuel injection events. For example, during a fuel injection event, needle valve 204 is lifted off the needle seat 242 so that fuel is injected into an engine cylinder (not shown).

Lower chamber 216 further includes fuel entry orifice 244 which is configured to supply fuel to the inner cavity of lower chamber 216. Cross-drilled fluid channels 246 in needle valve 204 also facilitate fuel flow throughout lower chamber 216. Control orifices 238 function to route fuel flow up valve seat central passage 240. When coils 221 are de-energized and solenoid 248 is in an inactive state, check ball 226 is in sealing engagement with pilot valve seat 224. Check ball 226 also functions as a moveable valve member and thus moves out of sealing engagement with pilot valve seat 224. When check ball 226 is in sealing engagement with pilot valve seat 224, fuel from lower chamber 216 is blocked from entering upper chamber 214. When fuel is supplied to lower chamber 216 and check ball 226 is in sealing engagement with pilot valve seat 224, the inner cavity of lower chamber 216 becomes a highly pressurized volume. When check ball 226 functions as a moveable valve member and moves out of sealing engagement with pilot valve seat 224, high pressure fuel flows up valve seat central passage 240 through pilot valve seat 224 and into the inner cavity of upper chamber 214.

Fuel injector 200 utilizes needle valve 204 in a normally closed position. When needle valve 204 is in a normally closed position, coils 221 are de-energized and solenoid 248 is in an inactive state. Fuel injector 200 also includes a plunger return spring 251 that exerts a spring force downwardly such that plunger 212 and armature 100 exert a downward force on check ball retainer 128, which thereby secures and retains check ball 226 into sealing engagement with pilot valve seat 224. Pressurized fuel is continuously supplied to the inner cavity of lower chamber 216.

When coils 121 are de-energized, fuel from lower chamber 216 is blocked from entering upper chamber 214, thus the inner cavity of lower chamber 216 becomes highly pressurized. Due to the fuel supply pressure acting downwardly on needle valve 204, a large downward hydraulic force pushes needle valve 204 in the downward direction. Needle spring 234 is also positioned in the inner cavity of lower chamber 216 and is compressed about the upper end of needle valve 204 such that when solenoid 248 is inactive, high pressure fuel as well as a downward spring force on needle valve 204 both act to secure needle valve 204 against needle valve seat 242. Securing needle valve 204 against needle valve seat 242 prevents high pressure fuel from exiting fuel injector 200 via injector orifice 236.

In an example use of armature 100 in fuel injector 200, flange 108 is positioned below solenoid 248 and coils 221. Plunger 212 includes a shaft portion that is disposed in and received by passage 112 of armature 100 to create a reciprocal connection such that when armature 100 moves in an upward direction, plunger 212 moves therewith. Armature spring 218 may be biased against the flange 108 to bias armature 100 and plunger 212 in the upward direction.

In an embodiment, armature 100 is configured to axially move in a fuel injector or other device as part of a valve assembly to facilitate opening and closing of the valve, such as valve 250 of fuel injector 200. In the illustrated embodiment of FIG. 6, stator assembly 222, which includes solenoid 248, may be disposed directly above armature 100 so that when solenoid 248 is in an active state, armature 100 moves to an upward position. When solenoid 248 is in an inactive state, armature 100 moves to a downward position. An air gap such as, for example, air gap 201 may provide a distance between stator assembly 222 and armature 100. End surface 114 at second end 106 of armature 100 may be supported by check ball retainer 230. Armature spring 218 may be biased against the flange 108 to bias armature 100 and plunger 212 in the upward direction.

Various aspects of the present disclosure are contemplated. According to a first aspect an armature for use in association with actuation of a valve is provided. The armature includes a body extending along a longitudinal axis between a first end and an opposite second. The body includes a flange at the first end and a shaft extending from the flange. The shaft extends along the longitudinal axis from the flange to the second end of the body. The body also includes a passage that extends along the longitudinal axis. The passage opens at the first and second ends of the body. The second end of the body includes an end surface extending around the passage. The end surface has a first portion extending around a second portion. The first portion of the end surface is flat and the second portion of the end surface is recessed from the first portion toward the first end of the body.

In an embodiment, the body is comprised of metal material. In an embodiment, the metal material is a soft magnetic iron-silicon alloy. In an embodiment, the metal material is vacuum annealed. In an embodiment, the body is formed by metal injection molding.

In an embodiment, the first portion is orthogonal to the longitudinal axis. In a further embodiment, the second portion is obliquely oriented to the first portion and obliquely oriented to the longitudinal axis. In a further embodiment, the second portion is planar. In a further embodiment, the second portion is tapered toward the first end at an angle that ranges from 0.1 degrees to 1 degree relative to the first portion.

In an embodiment, a ratio of an area of the second portion to an area of the first portion ranges from 4 to 7. In a further embodiment, the ratio is between 5 and 6.

In an embodiment, the flange extends radially outwardly from the passage at the first end of the body and the shaft extends from the flange along the passage.

In an embodiment, the passage includes a first diameter adjacent the second end of the body, a second diameter along a majority of a length of the passage between the first and second ends of the body, and the first diameter of the passage is greater than the second diameter of the passage.

In an embodiment, the shaft of the body includes an outer surface. The outer surface extends from the second end of the body to the flange. The outer surface has a stepped surface profile.

In a further embodiment, the stepped surface profile of the outer surface of the shaft includes a first shaft portion adjacent to the flange and a second shaft portion adjacent to the first shaft portion. The first shaft portion has a first outer diameter, and the second shaft portion has a second outer diameter. The second outer diameter is less than the first outer diameter. The outer surface of the shaft also includes a third shaft portion adjacent the second shaft portion. The third shaft portion extends from the second shaft portion to the second end of the body. The third shaft portion has a third outer diameter that is less than the second outer diameter.

According to another aspect, a method of fabricating an armature for use in association with actuation of a valve includes forming a monolithic metallic body using a metal material and a metal injection molding process and/or a bar machining process. The monolithic metallic body is formed to include a flange at a first end of the monolithic metallic body and a shaft extending from the flange along a longitudinal axis. The shaft extends to a second end of the monolithic metallic body that is opposite the first end. A passage that extends along the longitudinal axis opens at the first and second ends of the monolithic metallic body.

In an embodiment, the second end of the body includes an end surface extending around the passage. The end surface has a first portion extending around a second portion. The first portion of the end surface is flat. The second portion of the end surface extends from the first portion to the passage toward the first end of the body.

In an embodiment, the metal material is a soft magnetic iron-silicon alloy. In an embodiment, the monolithic metallic body is vacuum annealed after it is formed.

In an embodiment, the first portion is orthogonal to the longitudinal axis, and the second portion is tapered at an angle from first portion toward the first end monolithic metallic body.

While illustrative embodiments of the disclosure have been illustrated and described in detail in the drawings and foregoing description, the same is to be considered as illustrative and not restrictive in character, it being understood that only certain exemplary embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An armature for use in association with actuation of a valve, the armature comprising:
a body extending along a longitudinal axis between a first end and an opposite second, the body including:
a flange at the first end;
a shaft extending from the flange, the shaft extending along the longitudinal axis from the flange to the second end of the body; and
a passage that extends along the longitudinal axis, the passage opening at the first and second ends of the body, wherein the second end of the body includes an end surface extending around the passage, the end surface having a first portion extending around a second portion, wherein:
the first portion of the end surface is flat; and
the second portion of the end surface is recessed from the first portion toward the first end of the body.

2. The armature according to claim 1, wherein the body is comprised of metal material.

3. The armature according to claim 2, wherein the metal material is a soft magnetic iron-silicon alloy.

4. The armature according to claim 2, wherein the metal material is vacuum annealed.

5. The armature according to claim 2, wherein the body is formed by metal injection molding.

6. The armature according to claim 1, wherein the first portion of the end surface is orthogonal to the longitudinal axis of the body.

7. The armature according to claim 1, wherein the second portion of the end surface is obliquely oriented to the first portion of the end surface and obliquely oriented to the longitudinal axis of the body.

8. The armature according to claim 7, wherein the second portion is planar.

9. the armature according to claim 8, wherein the second portion of the end surface is tapered toward the first end at a range from 0.1 degrees to 1 degree relative to the first portion of the end surface.

10. The armature according to claim 1, wherein a ratio of an area of the second portion of the end surface to an area of the first portion of the end surface ranges from 4 to 7.

11. The armature according to claim 10, wherein the ratio is between 5 and 6.

12. The armature according to claim 1, wherein the flange extends radially outwardly from the passage at the first end of the body and the shaft extends from the flange along the passage.

13. The armature according to claim 1, wherein the passage includes:
a first diameter adjacent the second end of the body;
a second diameter along a majority of a length of the passage between the first and second ends of the body; and
the first diameter of the passage is greater than the second diameter of the passage.

14. The armature according to claim 1, wherein:
the shaft of the body includes an outer surface;
the outer surface extends from the second end of the body to the flange; and
the outer surface has a stepped surface profile.

15. The armature according to claim 14, wherein the stepped surface profile of the outer surface of the shaft includes:
a first shaft portion adjacent to the flange, the first shaft portion having a first outer diameter;
a second shaft portion adjacent to the first shaft portion, the second shaft portion having a second outer diameter, wherein the second outer diameter is less than the first outer diameter; and
a third shaft portion adjacent the second shaft portion, the third shaft portion extending from the second shaft portion to the second end of the body, the third shaft portion having a third outer diameter that is less than the second outer diameter.

16. A method of fabricating an armature for use in association with actuation of a valve, the method comprising:
forming a monolithic metallic body using a metal material and a metal injection molding process and/or bar machining process, the monolithic metallic body formed to include a flange at a first end of the monolithic metallic body, a shaft extending from the flange along a longitudinal axis, the shaft extending to a second end of the monolithic metallic body that is opposite the first end, and a passage that extends along the longitudinal axis and opens at the first and second ends of the monolithic metallic body.

17. The method according to claim 16, wherein the second end of the body includes an end surface extending around the passage, the end surface having a first portion extending around a second portion, wherein:
the first portion of the end surface is flat; and
the second portion of the end surface extends from the first portion to the passage toward the first end of the body.

18. The method according to claim 16, wherein the metal material is a soft magnetic iron-silicon alloy.

19. The method according to any of claim 18, wherein the monolithic metallic body is vacuum annealed after it is formed.

20. The method according to any of claim 16, wherein the first portion of the end surface is orthogonal to the longitudinal axis of the shaft, and the second portion of the end surface is tapered at an angle from first portion of the end surface toward the first end of the monolithic metallic body.
